(19) United States
(12) Patent Application Publication
(10) Pub. No.: US 2004/0196753 A1
(43) Pub. Date: Oct. 7, 2004

(54) Information carrier loading device

(75) Inventor: Stephane Marie Andre d'Alayer de Costemore d'Arc, Genappe (BE)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: STAAR S.A., Brussels (BE)

(21) Appl. No.: 10/816,507

(22) Filed: Apr. 1, 2004

(30) Foreign Application Priority Data
Apr. 2, 2003 (BE) 2003/0206

(51) Int. Cl. G11B 15/18; G11B 7/00

(52) U.S. Cl. 369/30.32; 369/30.31; 369/30.43

(57) ABSTRACT

A loading device for loading an information carrier into a recording/playback unit is provided. The loading device includes a pair of gripping elements that are actuatable to grip the information carrier therebetween. A transport mechanism moves the gripping elements during the loading of the information carrier. The gripping elements are supported by the transport mechanism for movement relative to the transport mechanism. A control mechanism is provided for actuating the gripping elements when the gripping elements are moved by the transport mechanism.

### FIELD OF THE INVENTION

This invention pertains to devices for loading/unloading information carriers in apparatuses for recording and/or playing back the information carried on the information carrier, and more particularly, to such devices that independently ensure the transfer of information carriers between operative and inoperative positions relative to the driving and playback systems for the information carriers.

### BACKGROUND OF THE INVENTION

Numerous devices for loading and unloading information carriers such as discs have been offered on the market. Some of such devices utilize rollers that pinch the disc such as described in EPA 0177232. However, the peripheral surface of those rollers, which are generally provided with rubber for gripping the disc, can be embedded with solid particles. Upon rotation of the rollers, these solid particles can scratch the surface of the discs significantly degrading the playback performance of the information carried on the disc and even destroying some information.

Another disc loading and unloading mechanism that is widely used is described in commonly owned U.S. Pat. No. 4,513,409. Unfortunately, this mechanism utilizes a helicoidal movement that requires free space at the periphery of the disc. As a result, this mechanism is less convenient for use in compact units.

Another disc loading and unloading device is disclosed in commonly owned U.S. Pat. No. 4,682,320. This device produces a rolling movement of the disc along its peripheral edge. However, this rolling movement tends to erode the peripheral edge of the disc and release burrs. Such burrs frequently form on the periphery of the disc during the molding process and the coating process wherein centrifugal forces are used to spread metallic liquid across the surface of the disc. The released burrs can become adhered to the disc or embedded in the rubber of the rollers, both of which lead to undesirable effects.

### OBJECTS AND BRIEF SUMMARY OF THE INVENTION

In view of the foregoing, an object of the present invention is to overcome the aforementioned drawbacks by providing a loading device for an information carrier that cooperates with a very reduced surface on the peripheral edge of the information carrier, thereby preventing any relative movement between the device and the information carrier.

Another object of the invention is to provide a loading device for an information carrier that has a very compact size, is simple, of low cost, easy to use and reliable.

Another object of the invention is to provide a loading device for an information carrier that ensures the clamping of the information carrier on its associated driving system and that can handle information carriers of different sizes and/or configurations.

To this end, the invention provides a loading device for loading an information carrier into a recording/playback unit. The loading device includes a pair of gripping elements that are actuatable to grip the information carrier therebetween. A transport mechanism moves the gripping elements during the loading of the information carrier. The gripping elements are supported by the transport mechanism for movement relative to the transport mechanism. A control mechanism is provided for actuating the gripping elements when the gripping elements are moved by the transport mechanism.

### BRIEF DESCRIPTION OF THE DRAWINGS

FIG. 1 is a top view of an illustrative recording and/or playback unit having a loading device according to the present invention showing an inoperative position of the unit and loading device corresponding to insertion or ejection of a relatively large information carrier,

FIG. 2 is a top view of the recording and/or playback unit of FIG. 1 showing the loading device gripping the information carrier,

FIG. 3 is a top view of the recording and/or playback unit of FIG. 1 showing the loading device having released the information carrier above its operative position,

FIG. 4 is a top view of the recording and/or playback unit of FIG. 1 showing the unit and the loading device in an operative position,

FIG. 5 is an enlarged partial section view of the recording and/or playback unit of FIG. 1 taken along the section plane 5-5 of FIG. 4 (or FIG. 12) showing part of the information carrier driving and clamping system,

FIG. 6 is an enlarged partial section view of the recording and/or playback unit of FIG. 1 similar to FIG. 5 showing the loading device gripping an information carrier,

FIG. 7 is an enlarged partial section view of the recording and/or playback unit of FIG. 1 taken along the section plane 7-7 of FIG. 3 (or FIG. 11),

FIG. 8 is an enlarged partial section view of the recording and/or playback unit of FIG. 1 similar to FIG. 7 showing the unit and loading device in the operative position,

FIG. 9 is perspective view of mechanism for preventing insertion of an information carrier into the unit when an information carrier is already in the unit,

FIG. 10 is a top view similar to FIG. 1 of an illustrative recording and/or playback unit having an alternative embodiment of a loading device according to the present invention that can also load relatively small information carriers,

FIG. 11 is a top view of the recording and/or playback unit of FIG. 10 showing the loading device having released the information carrier above its operative position,

FIG. 12 is a top view of the recording and/or playback unit of FIG. 10 showing the unit in the operative position.

### DETAILED DESCRIPTION OF THE INVENTION

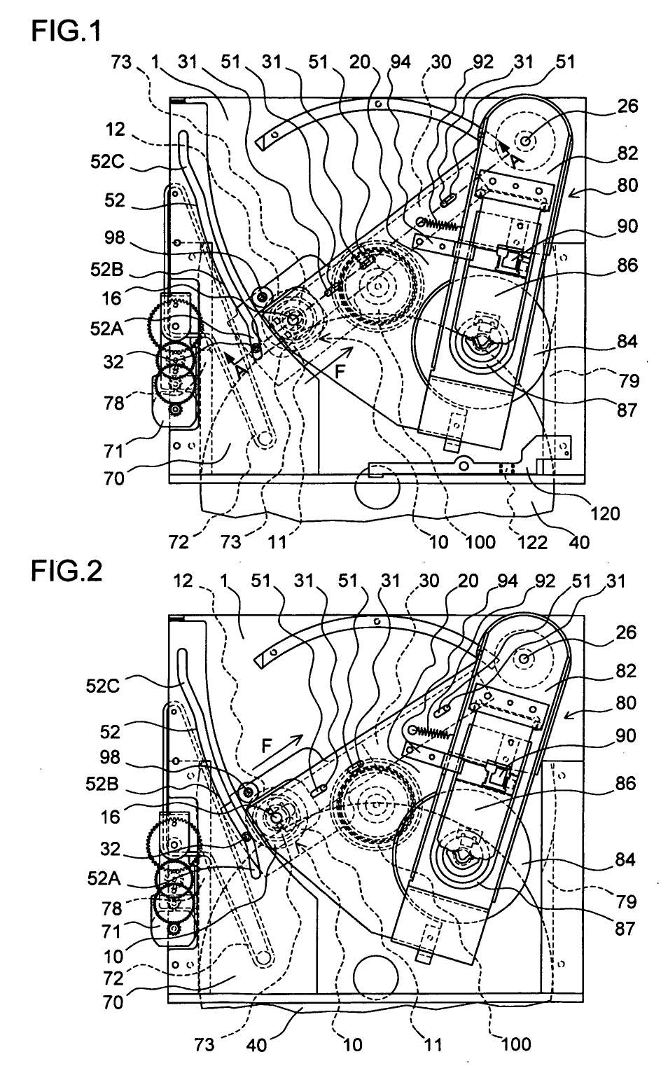

Referring to FIGS. 1-6 of the drawings, there is shown an exemplary recording and/or playback unit having a loading device for loading information carriers into recording and/or playback apparatuses or units (i.e. recording/playback units) according to the present invention. As will be appreciated by those skilled in the art, the present invention is applicable to any type or configuration of information carrier, including, among others, somewhat rigid carriers having a circular periphery such as so-called compact discs and DVDs and flexible or rigid information carriers enclosed in housings having a circular or parallelepiped shaped profile. Moreover, the invention is applicable to any type of recording/playback unit.

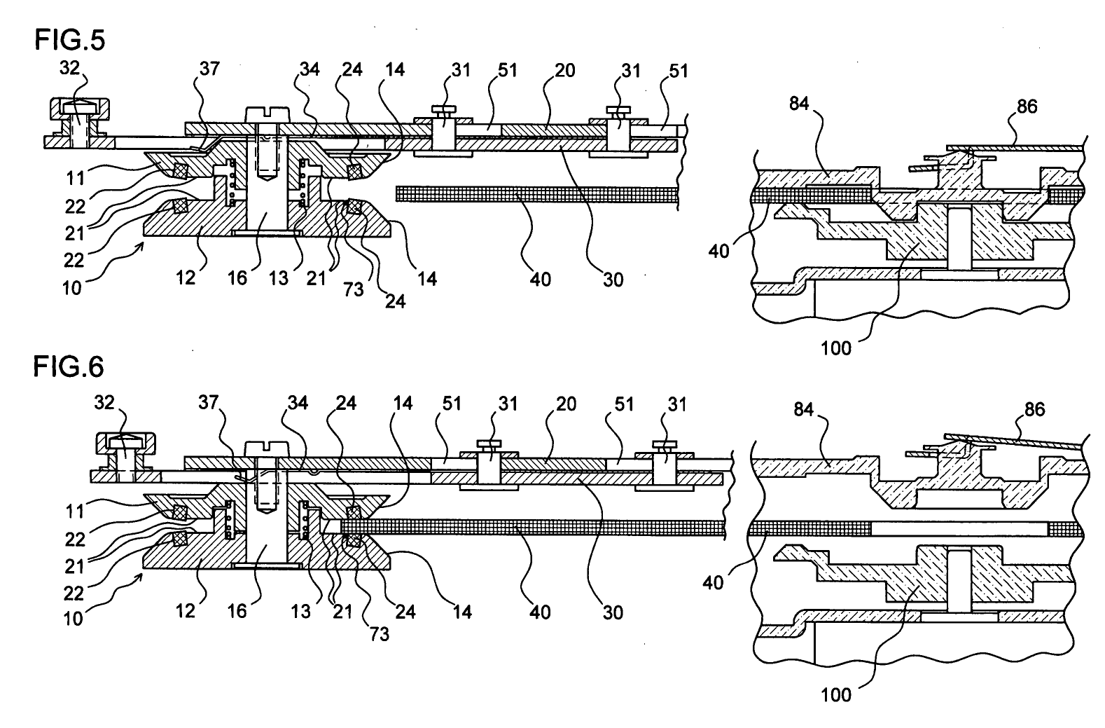

The illustrated loading device utilizes a gripping device 10 including preferably two elements 11, 12 (FIG. 5) that are movable with respect to each other. In the illustrated embodiment, the elements 11, 12 are partial disks held apart by a suitable, preferably resilient, mechanism 13, such as a spring. Preferably, the opposing surfaces 21 of the two elements 11, 12 provide good gripping. In the illustrated embodiment, each of these surfaces has a groove 22 for securing a rubber belt 24 that slightly overhangs the respective surface. Preferably, the belts 24 have a square cross-section, while the grooves 22 have a slightly tilted configuration so that the belts 24 act like a tightening wedge on the peripheral edge of a carrier 40, here a compact disc, held therebetween. Advantageously, the elements 11, 12 grip the disc 40 at the edge where data is not written or stored. The opposing surfaces of the two elements 11, 12 could also be partially or entirely covered with rubber, felt or any other material providing a good gripping coefficient. The peripheral edge of each of the elements 11, 12 preferably has an inclined, beveled profile 14 to facilitate insertion of the information carrier 40 therebetween. The profile of the elements 11, 12 are substantially circular, however any suitable profile can be used, such as an arc-shaped profile, linear profile, etc. The profile of the elements 11, 12 can be made to correspond to the shape of the information carrier. For instance, with discs, the elements 11, 12 can have a curvature which matches the curvature of the discs.

The elements 11, 12 are mounted for free rotation around a shaft 16 fixed on a transport mechanism 20 such as a mobile arm (FIGS. 1, 5, and 6). This arrangement is particularly advantageous because during the loading/unloading movements there is no relative movement between the information carrier 40 and the elements 11, 12. Any relative movement is restricted to between the arm 20 and the elements 11, 12 that are freely rotating around the shaft 16. Therefore, even if an impurity were located on one of the elements 11, 12 or in-between one of the belts 24 and the information carrier 40, it would not damage the carrier 40 because such impurity would remain perfectly immobile with respect to said carrier 40. However, as will be understood, the movement of rotation of the arm 20 around the shaft 26 is just an example of one possible movement. For example, a linear movement of the arm 20 is also feasible.

In the illustrated embodiment, as shown in FIGS. 5 and 6, a control mechanism 30, such as a slider or other appropriate element, is connected to the arm 20. The slider 30 is mounted on the arm 20 for movement relative to the arm 20 via studs 31 carried on the slider 30. The studs 31 cooperate with grooves 51 provided in the arm 20. This relative movement is, in the illustrated embodiment, powered by an element 32 such as a shaft attached to an end of the slider 30. The shaft 32 cooperates with an actuating mechanism 52 such as a groove or edge (FIGS. 1 to 4) provided in a fixed element 70 supported by the frame 1 of the unit. As one can easily understand, this relative movement could be powered by numerous other mechanisms, such as, for example, a groove or an edge located near the other end of the slider, a cam, a hairpin spring, an electromagnetic element, a micro-motor, etc. The slider 30 carries a tongue 34 that is attached thereon via the studs 31 and is located in-between the slider and the arm 20 (FIGS. 5 and 6). The end of the tongue 34 located nearest the mobile elements 11, 12 is bent so as to provide two “V” shaped tabs 37 located on each side of the shaft 16. During relative movement of the slider 30 and, in turn, the tongue 34, these tabs 37, move between a position wherein the tabs press against the upper surface of the element 11 (FIG. 6) thereby pushing the element 11 towards the element 12 against the bias of the spring 13 and wherein the tabs are cleared off of the upper surface of the element 11 (FIG. 5) so as to allow the spring 13 to move the element 11 away from the element 12. In alternative embodiments, the element 11 could be stationary and the element 12 movable or both elements 11, 12 could be movable.

For driving movement of the arm 20, the illustrated embodiment includes a micro-motor 71. The micro-motor 71 drives a belt 72 (FIGS. 1, 2) in this case a toothed and endless belt, through a gear train or any other appropriate mechanism and is a sub-element attached to the frame. This micro-motor is only ancillary to the present invention.

When loading a disc 40 having a relatively large diameter (FIG. 1), the user inserts it through the front slot of the unit. As the disc is being inserted, the elements 11, 12 are in the position shown in FIG. 5. The user pushes the disc until a detector 73 such a mechanical, optical or electronic detector is actuated by the presence of the disc. In a preferred embodiment, the detector is an optical detector using well-known components incorporated in one of the elements 11, 12, preferably the fixed element 12. As a result of actuation of the detector, the micro-motor 71 is powered on moving the belt 72, which, in turn, drives a clockwise rotation of the arm 20 around the shaft 26. During this movement, the shaft 32 rides along the profile of the groove 52 and more particularly its section/edge 52A. This forces the slider 30 and thus the tongue 34 to move in the direction of the arrow F. Upon this movement, the tabs 37 press against the upper face of the element 11 (FIG. 6) moving the element 11 towards the element 12 to grip a very limited surface at the peripheral edge of the disc between the belts 24.

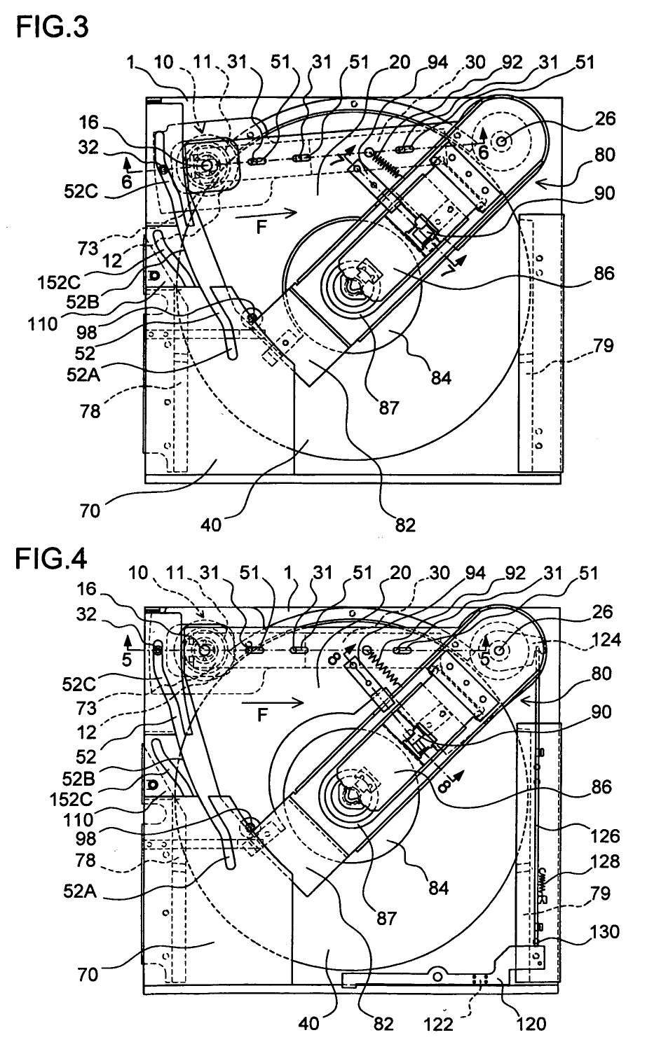

Upon further movement of the arm 20, the shaft 32 rides along the edge 52B (FIG. 2). This maintains the slider in position keeping the disc 40 gripped in-between the elements 11, 12 while the rotation of the arm 20 moves the elements 11, 12 and the disc 40 inside the unit from the position shown in FIG. 2 to the position shown in FIG. 3. As the disc moves it is guided by lateral guides 78, 79 inside the unit. During this movement, the elements 11, 12 and the information carrier 40 can, if necessary, rotate freely around the shaft 16. This allows the disc 40 to follow any desired loading path, notably one requiring the smallest volume, which is very advantageous for compact units. When the disc 40 reaches the record/playback position, the shaft 32 rides along the section 52C of the groove 52 (FIG. 3). This moves the slider 30 and the tongue 34 in the direction opposite to that of the arrow F. As a result, the tabs 37 leave the upper surface of the element 11, which is pushed upwards by the spring 13 and away from the element 12 to release the disc 40 over the driving system 100 of the unit. The level of the surface 21 of the element 12 is arranged very slightly above that of the driving system 100 of the unit (FIGS. 5 and 6). The arm 20 rotates further by some degrees to completely clear the elements 11, 12 off the disc 40 (FIG. 4). The disc is then set on the driving system 100 and can be freely rotated.

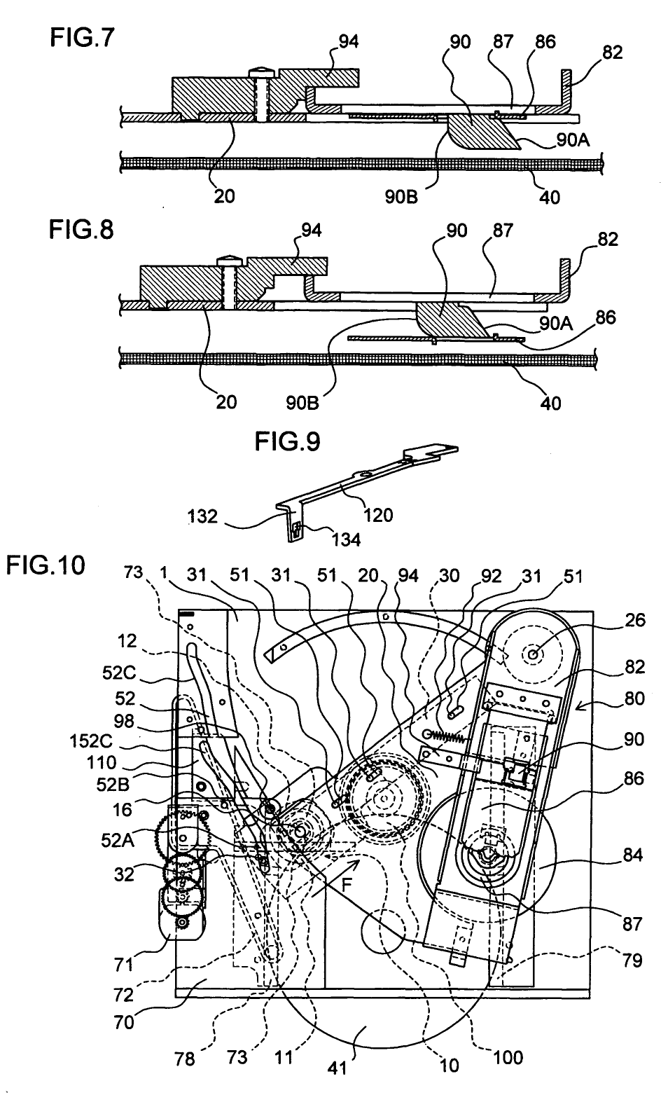

Preferably, a mechanism is provided to associate and/or synchronize the gripping device 10 with a holding or clamping system 80 for the disc 40 on the driving system 100 of the unit in order to eliminate the need for any additional mechanism. In the illustrated embodiment, the clamping system 80 for the disc includes an arm 82 that also rotates around the shaft 26. The clamping system further includes a plate 84 carried by a flexible tongue 86 (FIGS. 1, 5 and 6) that protrudes through an opening 87 provided in the arm 82. This tongue 86 is actuated by a control mechanism 90, such as an abutment (FIGS. 7, 8) attached to the arm 20. As shown in FIGS. 1 to 4, the arm 82 of the clamping system is connected to the arm 20 by a resilient mechanism such as a spring 92 while an abutment 94 arranged on the arm 20 limits the movement of the arm 82 in both the horizontal and vertical directions.

During its rotation, the arm 20, acting through the spring 92, rotates the arm 82 around the shaft 26 while the edge 90A of the control mechanism 90 keeps the tongue 86 at an upper level (FIG. 7). Thus, the clamping plate 84 is kept away from the disc 40 (FIG. 6). Next, an abutment 98 provided on the fixed element 70 in the vicinity of the groove 52 stops rotation of the arm 82 (FIG. 3). Upon further rotation of the arm 20, the abutment 90 moves away from the tongue 86 and thus releases the tongue because the edge 90A allows it to go down towards its low level. The edge 90B then applies a downward pressure (FIG. 8) on the tongue 86. As a result, the clamping plate 84 clamps the disc 40 on the driving system 100 (FIG. 5) so that both playback and recording of the information on the disc's surface can be performed.

During the unloading of a disc 40, the above described operations take place in the same way but in reverse order. Specifically, the micro-motor 71 is actuated to produce a clockwise movement of the belt 72, and thus a counterclockwise rotation of the arm 20. As shown in FIG. 7, the edge 90A of the abutment 90 cooperates with the tongue 86 to raise the tongue and thereby remove the plate 84 of the clamping system from the disc 40. This releases the disc from the driving system. Simultaneously, the element 12, more specifically the profile 14 of the element 12, engages the peripheral edge of the disc 40 while the shaft 32, riding along the section 52C of the groove 52 (FIG. 3), forces the slider 30 to perform a relative movement in the direction of the arrow F. Upon sliding, the tabs 37 press against the upper face of the element 11. This moves the element 11 towards the element 12. Further rotation of the arm 20 moves the disc 40 towards the front slot of the unit with the disc being guided in its movement by the lateral guides 78, 79. Near the eject position (FIG. 2), the shaft 32 rides along the section/edge 52A of the groove 52 which moves the slider 30 in the direction opposite to that of the arrow F. This movement clears the tabs 37 from the upper surface of the element 11. The element 11 is then pushed upwards by the spring 13. At this point, the disc 40 is protruding from the front slot of the unit (FIG. 1) to allow it to be gripped by a user. When the disc is in this position, its central hole is advantageously located outside the unit thus allowing the user to remove the disc by the central hole thereby preventing any contact with the disc's information surfaces.

The illustrated unit is further provided with a device preventing any insertion of a disc while another one is located within the unit. As shown on FIG. 4, the device comprises a shutter 120, pivoting around a pivot 122 set on the backside of the front panel of the unit and above the disc insertion slot and a control means 124 and a slider 126 arranged to the side. Near the completion of the loading movement of a disc 40, the control mechanism 124 fixed to the arm 20 and thus undergoing the rotation of said arm, abuts against the slider 126 to translate it against the action of a resilient mechanism 128. The slider 126 has an end 130 proximate the shutter 120 that is inclined to pivot the shutter 120 around the pivot 122 so that the opposing end of the slider, made of a bent portion 132 (see FIG. 9), is positioned in the middle of the disc insertion slot to partially close it and thus prevent any insertion of a disc 40. For convenience and increased visibility for the user, this bent portion 132 preferably incorporates a LED 134 that can be switched on by an appropriate circuit when a disc is in the unit.

Upon ejection of the disc 40, the rotation of the arm 20 and thus of the control mechanism 124 permits the slider 126 to slide backwards under the action of its resilient mechanism 128. This permits the shutter 120 to pivot clockwise towards a disengaged position wherein its bent portion 132 is arranged out of the disc insertion slot to allow the ejection of the loaded disc 40 and eventually let a new disc be inserted.

An alternative embodiment of the present invention is shown in FIGS. 10-12. In this embodiment, the loading device is configured to allow the loading/unloading of information carriers of different sizes, notably both discs having a large diameter (like those shown in FIGS. 1-4) and discs having a smaller diameter. To that end, the lateral guides 78, 79 are movable with respect to the fixed frame 1 of the unit. Additionally, the edge 52B of the groove 52 includes a movable element 110, the movement of which is connected to that of the lateral guides 78, 79. The movable element 110 of the groove includes a section 152C similar to the section 52C of the groove 52 of the first embodiment while the peripheral edge of the movable element 110 that faces the shaft 26 corresponds to the edge 52B of the groove 52 (FIGS. 3, 4).

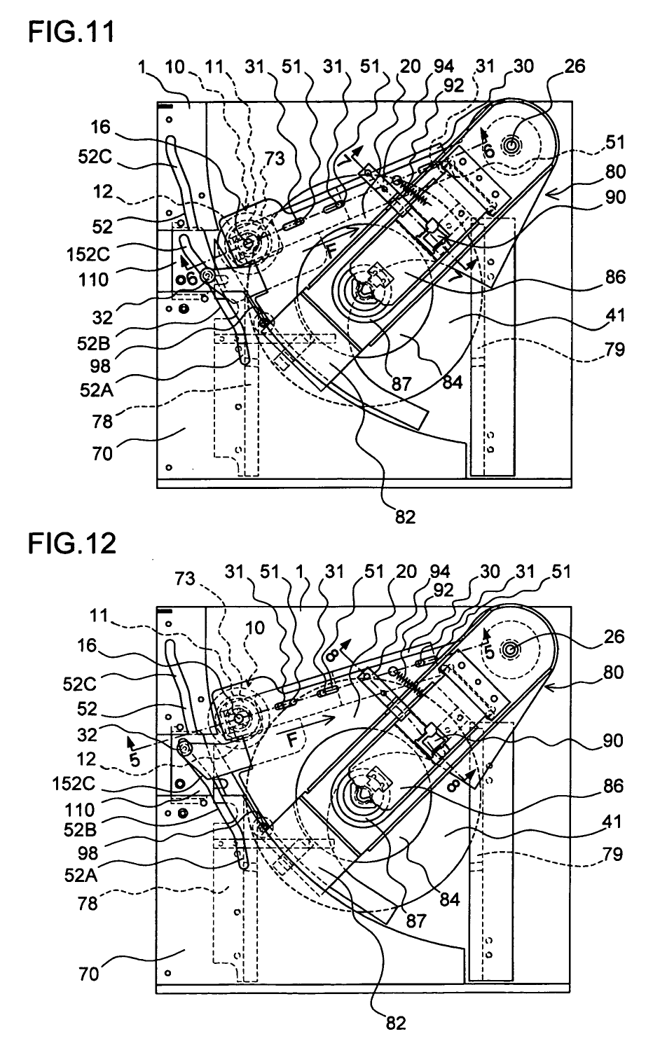

Upon insertion of a disc 41 having a relatively small diameter (FIG. 10), the presence of the disc is detected and as a result the micro-motor 71 powers rotation of the arm 20 in the clockwise direction. As previously described in connection with the first embodiment, the shaft 32 rides along the edge of the groove 52, with the edge 52A of the groove directing a movement of the element 11 towards the element 12 to grip the disc 41 (FIG. 6). Upon further movement of the arm, the shaft 32 enters the profile of the element 110 while the disc 41 remains gripped by the elements 11, 12 (FIG. 11) and its movement towards the record/playback operative position is guided by the lateral guides 78, 79. Next, the shaft 32 rides along the section 152C of the element 110 (FIG. 12) forcing the elements 11 and 12 to move apart in order to release the disc 41 when it is above the driving and/or playback system. The clamping system 80 is always kept away from the disc while the arm 20 rotates further to completely clear the elements 11, 12 off the disc 41. The disc 41 is then clamped on the driving system in the same way as in the first embodiment and rotated (FIGS. 4A, 5).

To unload the smaller diameter disc 41, the operations described above take place in the same way but in the reverse order. More specifically, the micro-motor 71 is actuated producing a counterclockwise rotation of the arm 20 which first raises the clamping system 80 off the disc 41 to release it from its driving system 100 (FIG. 11). The shaft 32 rides along the section 152C of the element 110 (FIG. 11) and this forces the elements 11 and 12 to move towards each other. The elements 11 and 12 push the disc 41 (its movement being guided by the lateral guides 78, 79) until the shaft 32 reaches the section 52A of the groove 52. The elements 11, 12 are then moved apart under the action of resilient mechanism and the disc 41 can then be removed by the user. The device is then ready to accept the insertion of another disc 40, 41.

Should a disc 40 having a relatively large diameter be inserted into the embodiment shown on FIGS. 10-12, the mobile lateral guides 78, 79 move apart. Simultaneously, the movable element 110, the movement of which is connected to that of the lateral guides 78, 79, moves out of the path of the shaft 32 so that the shaft rides only along the edge 52B and the section 52C of the groove 52, just as in the first embodiment (FIGS. 3 and 4). To unload the relatively larger diameter disc 40, the ejection operations take place in the same order as in the first embodiment until the user removes the disc 40. The lateral guides 78, 79 then move towards each other under the action of a well-known, and thus not illustrated, resilient mechanism and the movable element 110 sets itself again in the path of the shaft 32 at the position of the edge 52B of the groove 52. The unit is then ready to deal with any insertion of a disc 40, 41, whatever its diameter.

From the foregoing it will be appreciated that one advantage of the loading device of the present invention is that all the above-described elements of the loading device can be located above the information carrier. This leaves the space below the information carrier entirely free. As a result, manufacturers can use any available driving and playback system.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A loading device for loading an information carrier into a recording/playback unit comprising a pair of gripping elements actuatable to grip the information carrier therebetween; a transport mechanism for moving the gripping elements during loading of the information carrier, the gripping elements being supported by the transport mechanism for movement relative to the transport mechanism; and a control mechanism for actuating the gripping elements when the gripping elements are moved by the transport mechanism.

2. The loading device according to claim 1 wherein the control mechanism is movable relative to the transport mechanism.

3. The loading device according to claim 1 wherein upon movement of the transport mechanism the control mechanism engages one of the gripping elements to move said one of the gripping elements relative to the other of the gripping elements.

4. The loading device according to claim 1 wherein the actuation of the gripping elements to grip the information carrier is counter to the force of a resilient member which normally biases the gripping elements to an open position wherein the gripping elements are disengaged from the information carrier.

5. The loading device according to claim 1 wherein the gripping elements are supported on the transport mechanism for rotation relative to the transport mechanism.

6. The loading device according to claim 1 wherein each of the gripping elements has a gripping surface for engaging the information carrier and an inclined peripheral profile.

7. The loading device according to claim 1 wherein the gripping elements grip a peripheral edge of the information carrier.

8. The loading device according to claim 1 further including a movable clamping system for securing the information carrier in an operative position relative to a drive system for playing or recording information on the information carrier and wherein the clamping system is connected to the transport mechanism.

9. The loading device according to claim 8 wherein the transport mechanism includes an actuating mechanism engageable with the clamping system and operative to move the clamping system between a disengaged position and an engaged position relative to the information carrier and the drive system.

10. The loading device according to claim 9 wherein relative movement between the transport mechanism and the clamping system actuates the actuating mechanism thereby moving the clamping system between the disengaged and engaged positions.

11. The loading device according to claim 8 wherein the transport mechanism and the clamping system are rotatable around a fixed shaft.

12. The loading device according to claim 2 wherein the movement of the control mechanism relative to the transport mechanism is produced by an actuating device.

13. The loading device according to claim 12 wherein the actuating device includes an edge.

14. The loading device according to claim 12 wherein the actuating device includes a movable element.

15. The loading device according to claim 14 wherein the movable element includes a groove.

16. The loading device according to claim 14 wherein a peripheral edge of the movable element actuates the actuating device.

17. The loading device according to claim 1 further including a device actuated by movement of the transport mechanism that prevents loading of a second information carrier into the recording/playback unit when a first information carrier is loaded in the recording/playback unit.

18. A loading device for loading an information carrier into a recording/playback unit comprising:
a pair of gripping elements actuatable to grip the information carrier therebetween;
a transport mechanism for moving the gripping elements during loading of the information carrier;
a control mechanism for actuating the gripping elements when the gripping elements are moved by the transport mechanism, the control mechanism being movable relative to the transport mechanism and wherein upon movement of the transport mechanism the control mechanism engages one of the gripping elements to move said one of the gripping elements relative to the other of the gripping elements; and
an actuating device for moving the control mechanism relative to the transport mechanism.

19. The loading device according to claim 18 wherein the actuating device includes an element that moves to accommodate information carriers of different size.

20. The loading device according to claim 19 wherein the movable element includes a groove.

21. The loading device according to claim 20 wherein a peripheral edge of the movable element actuates the actuating device.

22. The loading device according to claim 19 further including guides for the information carrier that are movable to accommodate information carriers of different size and wherein the movable element moves in response to movement of movable guides.

22. The loading device according to claim 18 wherein the actuation of the gripping elements to grip the information carrier is counter to the force of a resilient member which normally biases the gripping elements to an open position wherein the gripping elements are disengaged from the information carrier.

23. The loading device according to claim 18 wherein the gripping elements grip a peripheral edge of the information carrier.

24. A loading device for loading an information carrier into a recording/playback unit comprising:
a pair of gripping elements actuatable to grip the information carrier therebetween;
a transport mechanism for moving the gripping elements during loading of the information carrier;
a control mechanism for actuating the gripping elements when the gripping elements are moved by the transport mechanism;
a movable clamping system for securing the information carrier in an operative position relative to a drive system for playing or recording information on the information carrier, the clamping system being connected to the transport mechanism, wherein the control mechanism actuates the gripping element to release the information carrier when the information carrier is in the operative position; and
an actuating mechanism associated with the transport mechanism and engageable with the clamping system and operative to move the clamping system between a disengaged position and an engaged position relative to the information carrier and the drive system.

25. The loading device according to claim 24 wherein relative movement between the transport mechanism and the clamping system actuates the actuating mechanism thereby moving the clamping system between the disengaged and engaged positions.

26. The loading device according to claim 24 wherein the control mechanism is movable relative to the transport mechanism.

27. The loading device according to claim 26 wherein the movement of the control mechanism relative to the transport mechanism is produced by an actuating device.

28. The loading device according to claim 27 wherein the actuating device includes an edge.

29. The loading device according to claim 27 wherein the actuating device includes a movable element.

30. The loading device according to claim 24 wherein the actuation of the gripping elements to grip the information carrier is counter to the force of a resilient member which normally biases the gripping elements to an open position wherein the gripping elements are disengaged from the information carrier.

31. A loading device for loading an information carrier into a recording/playback unit comprising:
a pair of gripping elements actuatable to grip the information carrier therebetween;
a transport mechanism for moving the gripping elements during loading of the information carrier, the gripping elements being supported by the transport mechanism for movement relative to the transport mechanism; and
guide elements for guiding movement of the information carrier as the information carrier is loaded and unloaded from the recording/playback unit.

32. The loading device according to claim 31 further including a control mechanism for actuating the gripping element when the gripping elements are moved by the transport mechanism and wherein the control mechanism is movable relative to the transport mechanism.

33. The loading device according to claim 31 wherein the actuation of the gripping elements to grip the information carrier is counter to the force of a resilient member which normally biases the gripping elements to an open position wherein the gripping elements are disengaged from the information carrier.

34. The loading device according to claim 31 wherein the gripping elements are supported on the transport mechanism for rotation relative to the transport mechanism.

35. The loading device according to claim 31 wherein the gripping elements grip a peripheral edge of the information carrier.

36. The loading device according to claim 32 wherein the movement of the control mechanism relative to the transport mechanism is produced by an actuating device.

37. The loading device according to claim 36 wherein the actuating device includes an element that moves to accommodate information carriers of different size.

38. The loading device according to claim 37 wherein the movable element includes a groove.

39. The loading device according to claim 37 wherein a peripheral edge of the movable element actuates the actuating device.

40. The loading device according to claim 37 wherein the guide elements for the information carrier are movable to accommodate information carriers of different size and wherein the movable element moves in response to movement of movable guides.
